(19) United States
(12) Patent Application Publication
(10) Pub. No.: US 2013/0207611 A1
(43) Pub. Date: Aug. 15, 2013

(54) SYSTEM AND METHOD OF MANAGING A LITHIUM ION BATTERY PACK IN A WALK MOWER

(71) Applicant: Timothy P. Sosnowski, Eden Prairie, MN (US)

(72) Inventor: Timothy P. Sosnowski, Eden Prairie, MN (US)

(21) Appl. No.: 13/370,083

(22) Filed: Feb. 9, 2012

(51) Int. Cl. H02J 7/00

(52) U.S. Cl. CPC H02J 7/00
USPC 320/134

(57) ABSTRACT

A walk mower comprises a traction frame having a reel cutting unit and a traction drum which are both driven from an electric motor carried on the traction frame. The electric motor is powered by a lithium ion battery pack carried on the traction frame. A charger is provided for recharging the battery pack. Once a fully charged level of the battery pack is reached, a battery management system initiates a sleep period countdown. At the conclusion of the countdown, the charger discharges the battery pack if the mower has not been used during the countdown period to a reduced state of charge level. The state of charge is maintained at this reduced level during a plurality of successive sleep periods in a storage state of charge range.

### TECHNICAL FIELD

This invention relates to electrically powered mowers for cutting grass and, more particularly, to such a mower having a lithium ion battery pack.

### BACKGROUND OF THE INVENTION

Walk reel mowers are known for the precision cutting of grass to very low heights of cut. Such mowers are most commonly used for cutting the grass on the greens of golf courses and thus are typically referred to as greensmowers. The mower includes a reel cutting unit having a rotatable reel that sweeps the grass against a sharpened bedknife for cutting the grass between the blades of the reel and the bedknife. The mower is self-propelled by a power source carried on the mower which is operatively connected to a rotatable, ground engaging traction drum carried on the mower.

The power source on some known mowers of this type comprises one or more electric drive motors that are used not only to rotate the traction drum but the rotatable reel as well. A battery pack carried on the mower is used as a source of electrical power for the electric drive motors, whether there is only one such electric motor or multiple motors. Traditionally, the battery pack comprises one or more lead acid batteries.

Unfortunately, a lead-acid battery pack does not provide much range for the mower. A mower using a lead-acid battery pack may be good for cutting only one or two greens before the battery pack becomes depleted. This requires that the battery pack either be recharged or be replaced with a spare, fully charged battery pack. Either alternative is time consuming and unattractive.

Accordingly, it would be an advance in the mower art to provide a mower having at least one electric motor used for self-propelling the mower and for rotating the reel with the mower having more range than can be provided when powering the electric motor from a lead-acid battery pack.

### SUMMARY OF THE INVENTION

One aspect of this invention relates to a method comprising providing a mower for cutting grass having at least one electric motor carried thereon, the electric motor driving at least one component of the mower, and a lithium ion battery pack being carried on the mower for providing electrical power to the electric motor. The method further comprises providing a charger for charging the battery pack. Additionally the method comprises managing the state of charge of the pack in the following manner: using the charger to charge the battery pack to a substantially fully charged state of charge level; and discharging the battery pack to a state of charge level that is reduced compared to the fully charged state of charge level at the conclusion of a predetermined period of time if the mower was not in use since the fully charged state of charge level was established.

### BRIEF DESCRIPTION OF THE DRAWINGS

This invention will be described in the following Detailed Description when taken in conjunction with the drawings in which like reference numerals refer to like elements throughout.

FIG. 1 is a perspective view of one embodiment of an electrically powered mower according to this invention, particularly illustrating a mower powered by a lithium ion battery pack; and

FIGS. 2-8 comprise flow charts showing various routines that form a method of managing the battery pack in the mower of FIG. 1, particularly illustrating a “Charger Power Up” routine in FIGS. 2A-2B, a “Pack State At Last Shutdown” routine in FIGS. 3A-3D; a “Charge” routine in FIGS. 4A-4C, a “Charge_Storage” routine in FIGS. 5A-5B, a “Charge_Done” routine in FIG. 6, a “Storage” routine in FIG. 7, and a “Discharge” routine in FIG. 8.

### DETAILED DESCRIPTION

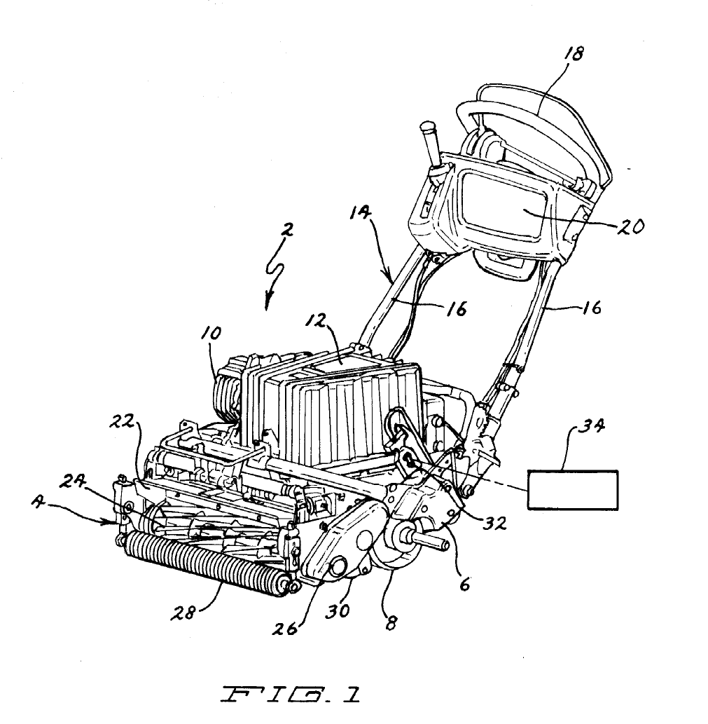

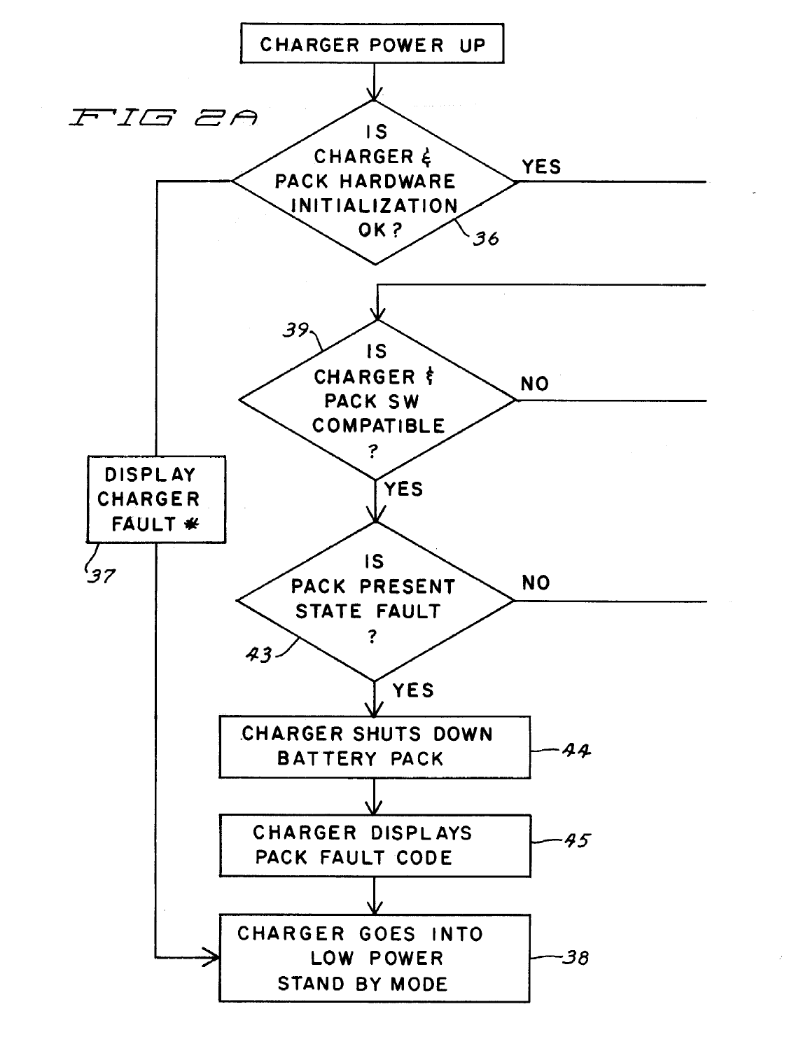

A mower according to this invention is generally illustrated as 2 in FIG. 1. Mower 2 preferably comprises a walk greensmower having a reel cutting unit 4 for precision mowing of grass at low heights of cut on golf course greens or the like. However, mower 2 is not limited to being a greensmower or even a reel mower but may comprise mowers of other types. For example, mower 2 could comprise a rotary mower having one or more grass cutting blades that rotate about vertical axes in horizontal cutting planes.

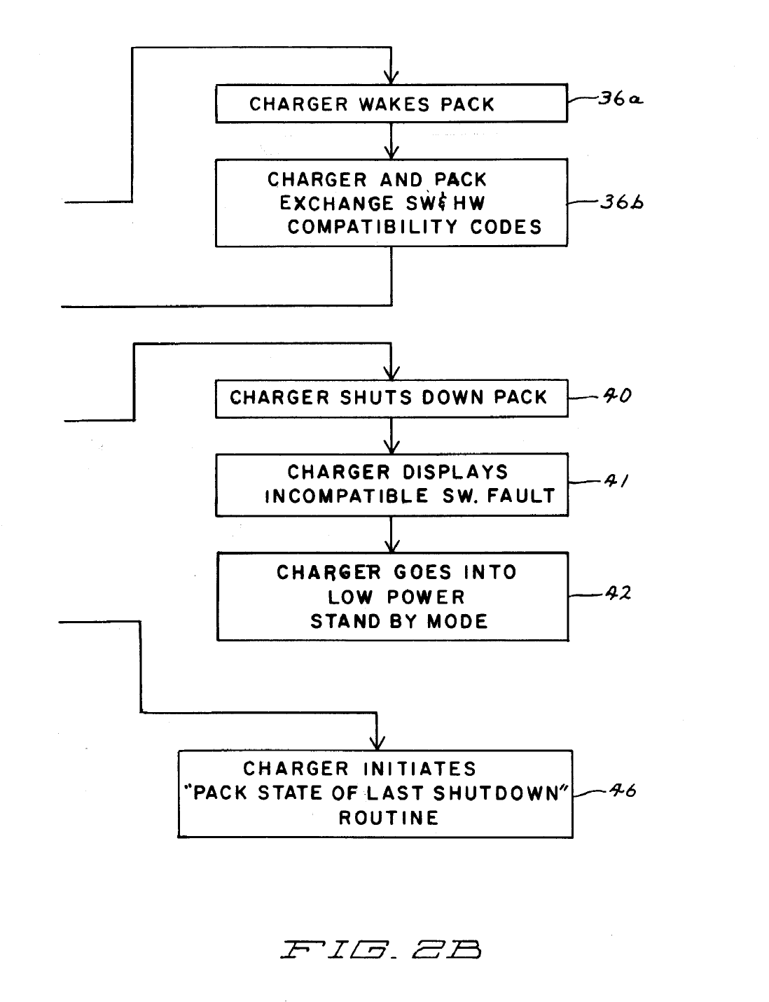

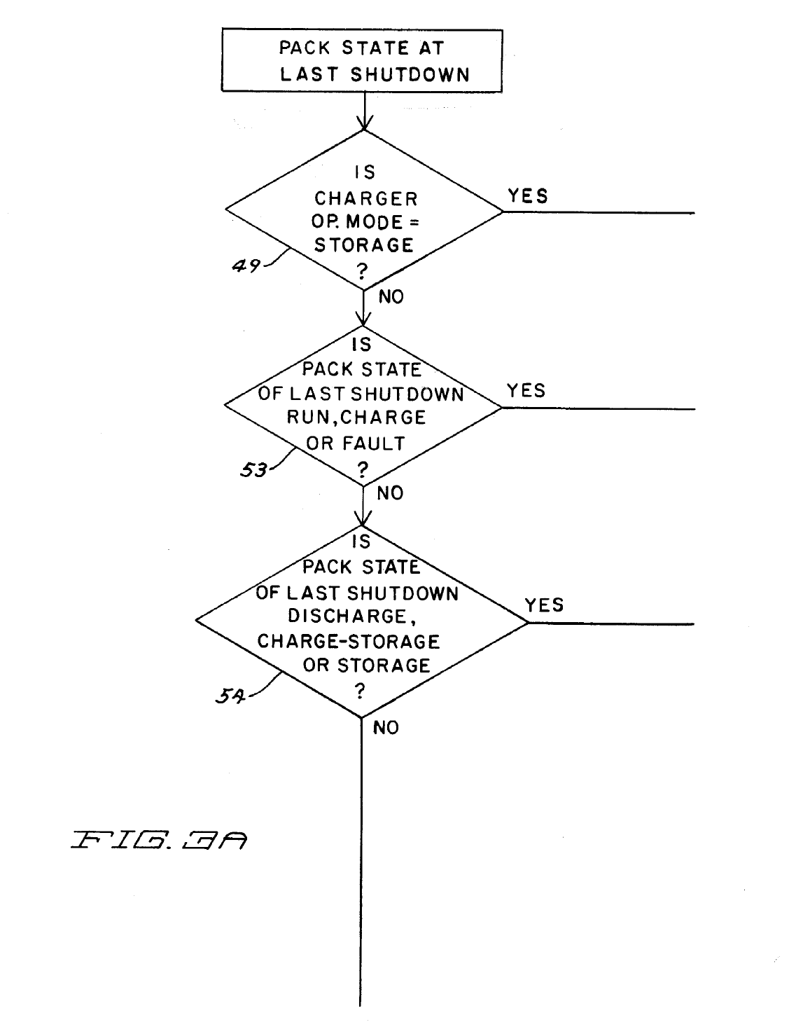

Referring to both FIGS. 1 and 2, mower 2 comprises a traction frame 6 that is supported by a ground engaging traction drum 8 which is split into separate left and right drum halves. Traction frame 6 mounts a power source comprising an electric motor 10 that is operatively coupled to a lithium ion (Li+) battery pack 12 that supplies electrical power over a wiring harness to motor 10. Motor 10 is operatively coupled to traction drum 8 through a traction drive system for rotating traction drum 8 when motor 10 is operating to self-propel mower 2 over the ground. Traction drive system 12 includes a differential (not shown) that is built into traction drum 8 for allowing the left and right drum halves to rotate at different speeds during turns of mower 2.

A generally U-shaped upwardly and rearwardly extending handle assembly 14 is provided at the rear of traction frame 6 to allow an operator who walks on the ground behind traction frame 6 to guide and manipulate mower 2 during operation of mower 2. Handle assembly 14 includes laterally spaced left and right handle tubes 16 that are attached at their lower ends to opposite sides of traction frame 6. Handle tubes 16 are joined together at their upper ends by a laterally extending hand grip 18 which the operator can hold onto when operating mower 2. A control panel 20 extends between the upper ends of handle tubes 16 and is located slightly below hand grip 18.

Traction frame 6 mounts cutting unit 4 thereon in advance of engine 10 and in advance of traction drum 8. Cutting unit 4 comprises a cutting unit frame 22 that carries a helically bladed reel 24 that is journalled between spaced side plates of cutting unit frame 22 for rotation about a substantially horizontal axis. A bedknife is fixed to cutting unit frame 22 below and closely adjacent to the outer diameter of reel 24 so that grass is cut by a shearing action when the blades of reel 24 sweep uncut stalks of grass against a sharpened front edge of the bedknife. A cutting reel drive system 26 operatively powers reel 24 from motor 10. Cutting unit frame 22 is supported by its own front and rear ground engaging rollers 28 and 30, respectively.

Cutting unit 4 at the front of mower 2 is pivotally coupled to traction frame 6 by a suspension system that allows cutting unit 4 to conform to ground contours independently of traction frame 6. More particularly, the suspension system provides cutting unit 4 with the ability to pitch fore-and-aft about a substantially horizontal, laterally extending pitch axis and to roll side-to-side about a substantially horizontal, longitudinally extending roll axis. U.S. Pat. No. 7,191,584, which is assigned to The Toro Company, the assignee of this invention, and which is hereby incorporated by reference, discloses a suspension system that can be used on mower 2 for providing pitch and roll to cutting unit 4.

A charger 34, represented in block diagram form in FIG. 1, is provided for recharging pack 12. Charger 34 is not normally carried on mower 2. Instead, charger 34 will usually be kept at a mower maintenance site separately from mower 2. At the end of a mowing session, mower 2 is returned to the maintenance site. A plug 32 on pack 12 is plugged into charger 34 to replenish the state of charge (SOC) of pack 12. Both pack 12 and charger 34 have microprocessor based controllers that communicate in a two way manner with one another over a CAN bus. Charger 34 has a display (not shown) capable of displaying various informational codes to an operator or mechanic of mower 2.

This invention relates to a battery management system and method for controlling and maintaining the SOC of pack 12 using charger 34. The method of this invention begins with a Charger Power Up routine shown in FIGS. 2A and 2B when mower 2 is plugged into charger 34 and charger 34 is powered up. The Charger Power Up routine is initiated by plugging charger 34 into an electrical socket to receive mains power from the socket and by switching charger 34 on. The Charger Power Up routine begins with a logic block 36 that determines whether the hardware of charger 34 and pack 12 are operating properly. If No, a fault code is displayed on charger 34 in block 37 to visually indicate this failure and charger 34 is sent into a low power stand by mode at block 38.

If the hardware of charger 34 and pack 12 are determined to be operating properly, charger 34 “wakes up” pack 12 in block 36a by grounding a pin in plug 32. This causes the battery processor to boot and begin functional operations. In block 36b, charger 34 and pack 12 exchange Hardware (HW) and Software (SW) compatibility information over the CAN bus. The next logic block 39 performed in the Charger Power Up routine is to determine if the software releases contained within charger 34 and pack 12, as well as the hardware in charger 34 and pack 12, are compatible with one another. If No, charger 34 shuts down pack 12 at block 40, displays an incompatibility fault at block 41 and returns to the low power stand by mode at block 42. However, if the answer at logic block 39 is Yes, then logic block 43 is performed next to determine if pack 12 is reporting a fault to charger 34. If Yes, charger 34 shuts down pack 12 at block 44, displays a different code indicating a fault in pack 12 at block 45, and goes into low power stand by mode at block 38. However, if pack 12 does not report a fault at logic block 43, the Charger Power Up routine branches to block 46 in which charger 34 initiates the Pack State At Last Shutdown routine.

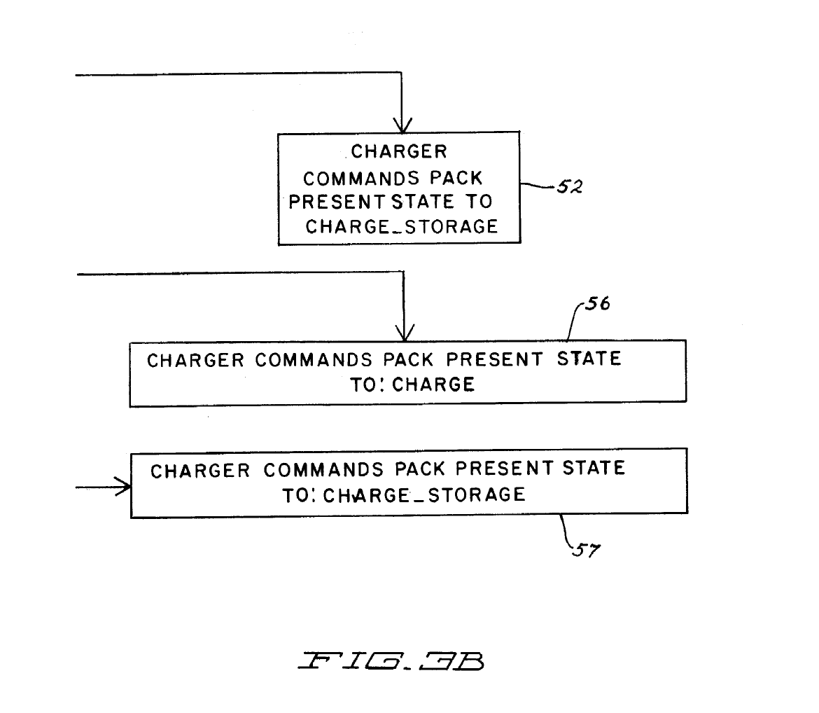

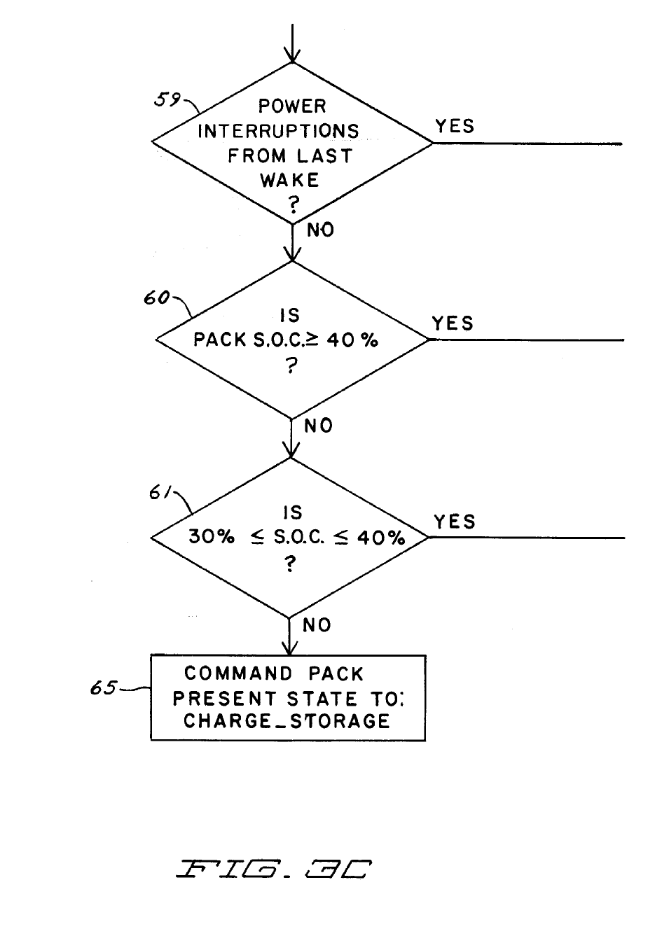

The Pack State At Last Shutdown routine is illustrated in FIGS. 3A-3D. Charger 34 has two operational modes: Standard and Storage. The Pack State At Last Shutdown routine is valid in either of the Standard and Storage operational modes of charger 34. In the Standard mode, charger 34 first charges pack 12 and then waits for a predetermined time before discharging pack 12 to a lower state of charge (SOC) level, as will be described in more detail hereafter. In the Storage mode, charger 34 maintains a reduced SOC level in pack 12.

The Pack State At Last Shutdown routine begins with a first logic block 49 to determine the operational mode of charger 34. If charger 34 is in the Storage operational mode, the routine branches to logic block 52, where charger 34 commands pack 12 to CHARGE_STORAGE.

If the answer is No at logic block 49, this means charger 34 is in the Standard operational mode. Then, the Pack State At Last Shutdown routine goes through a series of sequential logic blocks 53 and 54 to determine if the state of pack 12 at its last shutdown was equal to the following states: Run, Charge, or Fault in logic block 53, and Discharge, Charge_Storage, or Storage in logic block 54. Depending on the answers, charger 34 will command the pack present state to one of the states Charge or Charge_Storage at blocks 56 and 57. If neither logic block 53 nor logic block 54 is true, then the pack State at Last Shutdown had to have been Charge_Done. Basically, this portion of the Pack State At Last Shutdown routine in FIGS. 3A-3D determines the state of pack 12 at the time pack 12 was last shutdown.

In addition, the Pack State At Last Shutdown routine has a number of additional logic blocks 59-62 that determines what steps charger 34 should take when waking a pack 12 with the state of last shutdown of Charge Done. Logic Block 59 first determines if power to pack 12 has been interrupted from the last time pack 12 was awakened by charger. If the answer is Yes, then the charger no longer knows how long it has truly been in the low power standby mode, so it needs to take alternative steps as determined by logic block 62. Logic block 62 asks if the SOC of pack 12 is greater than or equal to 30% (the SOC storage low limit). If Yes, charger 34 commands the pack present state to Charge_Done. If No, charger 34 commands the pack present state to Charge_Storage. The logic is implemented in this manner to prevent the pack from being discharged to the low SOC state too early, but to also prevent the pack from getting into too low of a charge state.

If the answer is No at logic block 59 indicating the absence of any power interruptions, logic block 60 commands the pack present state to Discharge at block 63 if the SOC is greater than or equal to 40% (the SOC storage high limit). If the answer at logic block 60 is No, logic block 61 commands the pack present state to Storage at block 64 if the SOC is between 30% and 40% and to Charge_Storage at block 65 if the SOC is less than 30%. Basically, the final portion of the Pack State At Last Shutdown routine beginning with logic block 59 sets the pack present state in accordance with both the state at last shutdown of the pack and the actual SOC of pack 12 rather than in accordance with only the state of pack 12 at its last shutdown.

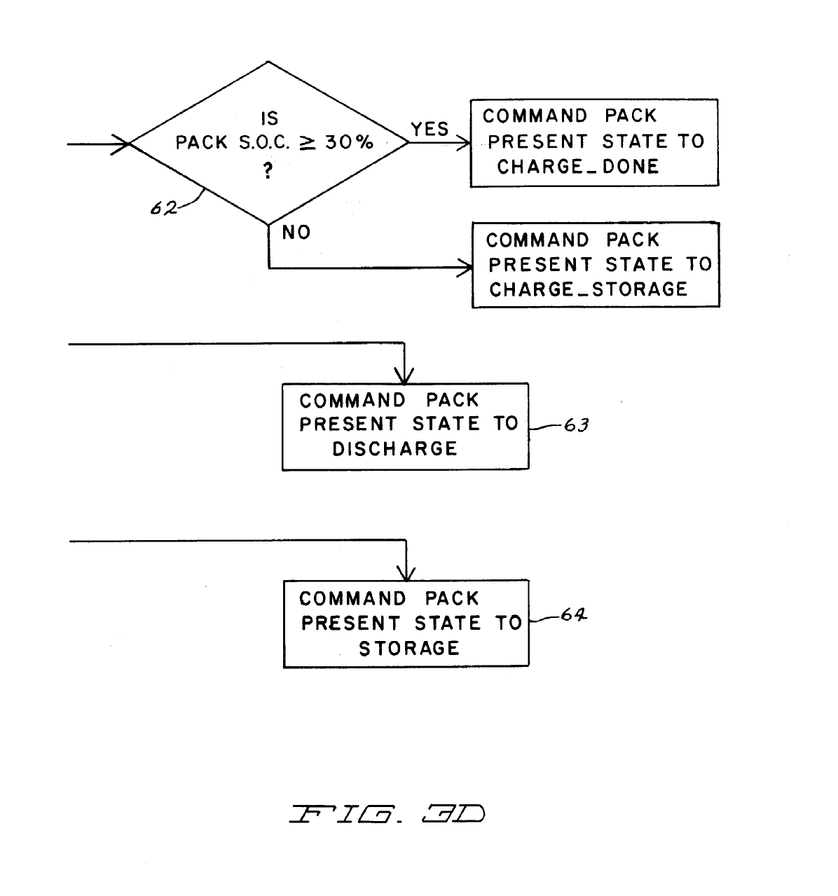

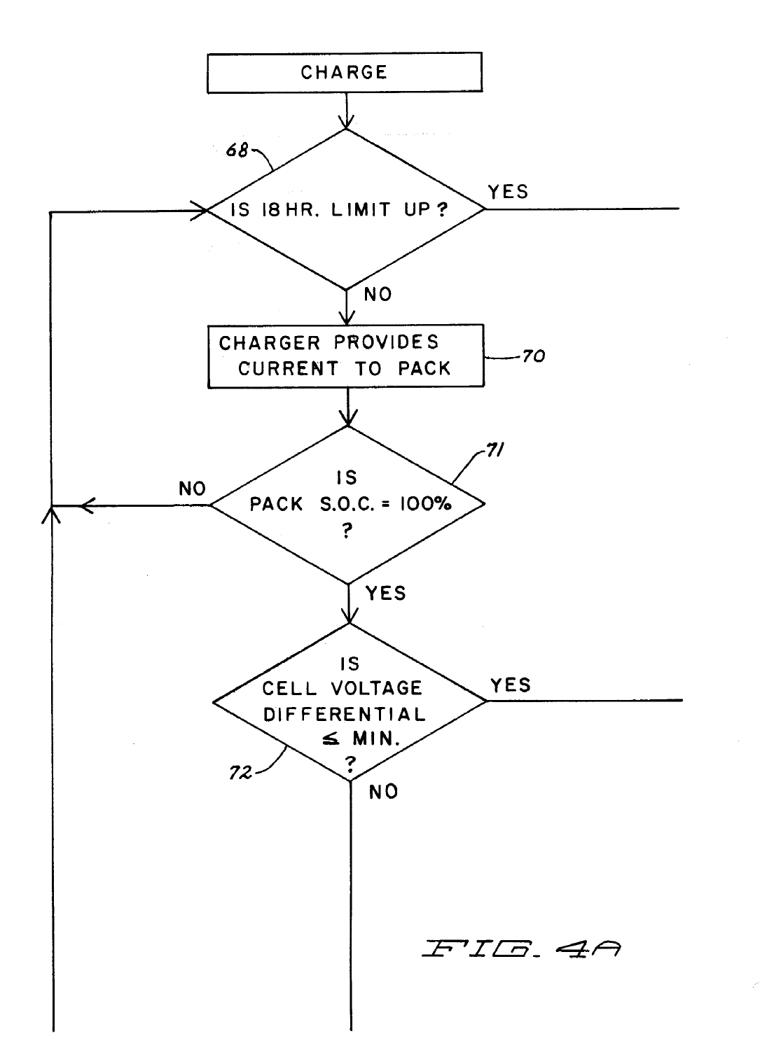

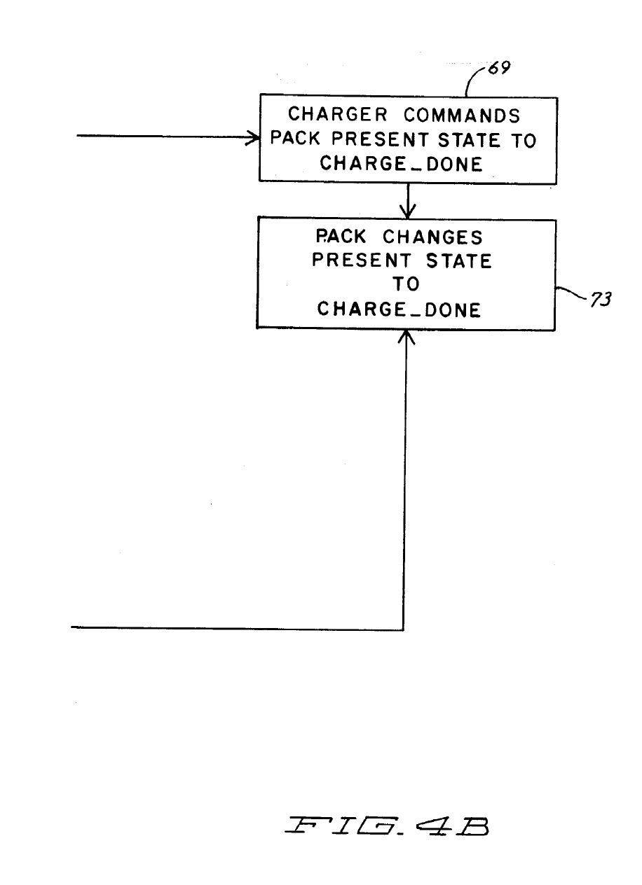

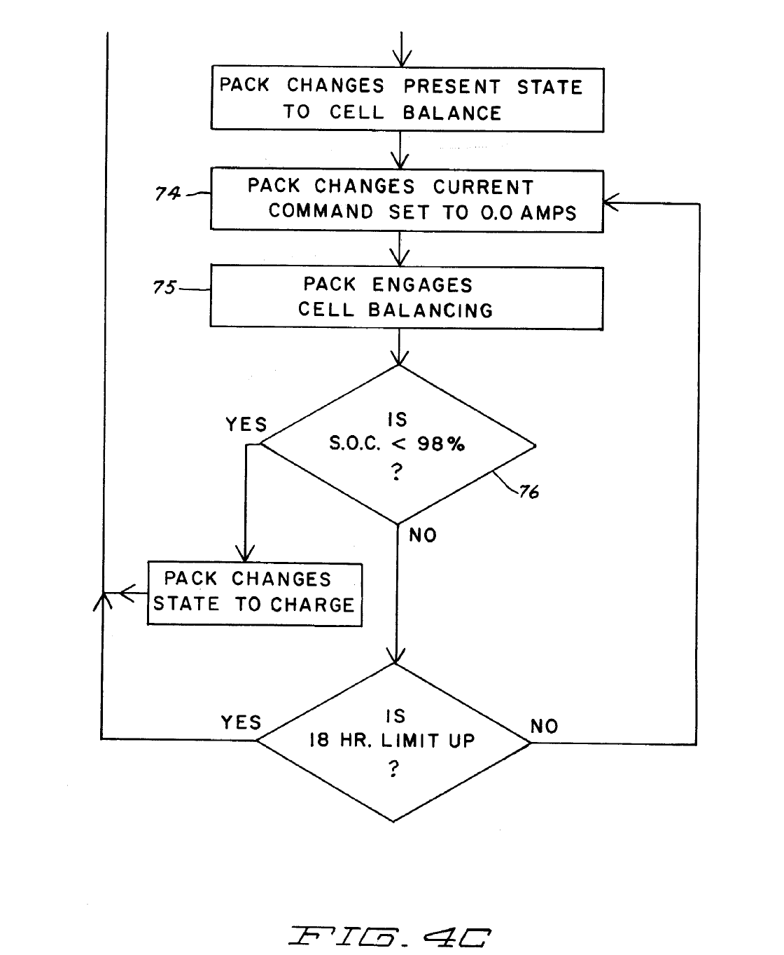

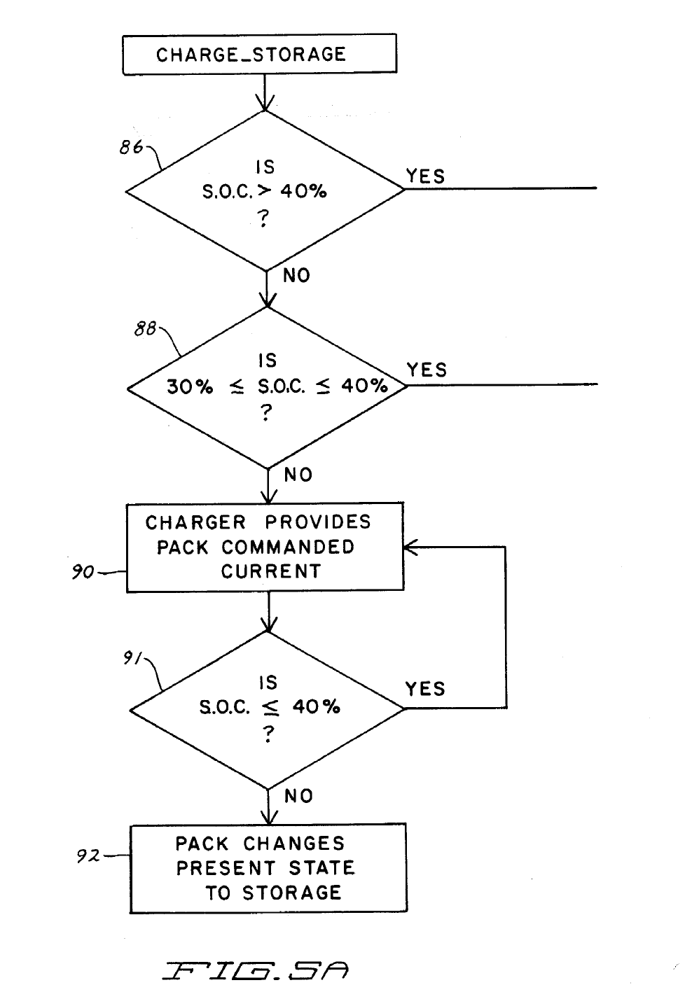

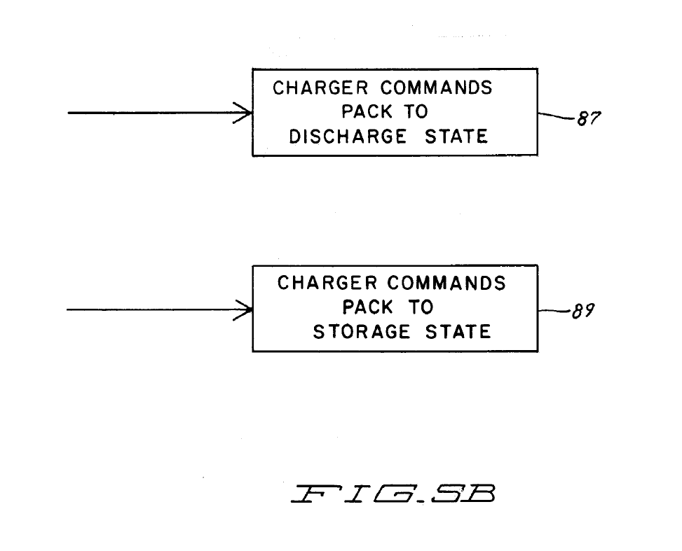

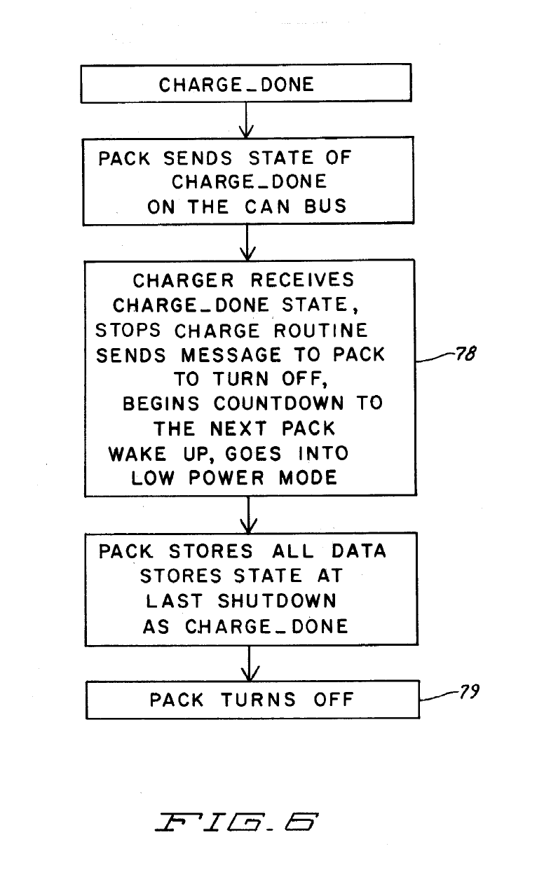

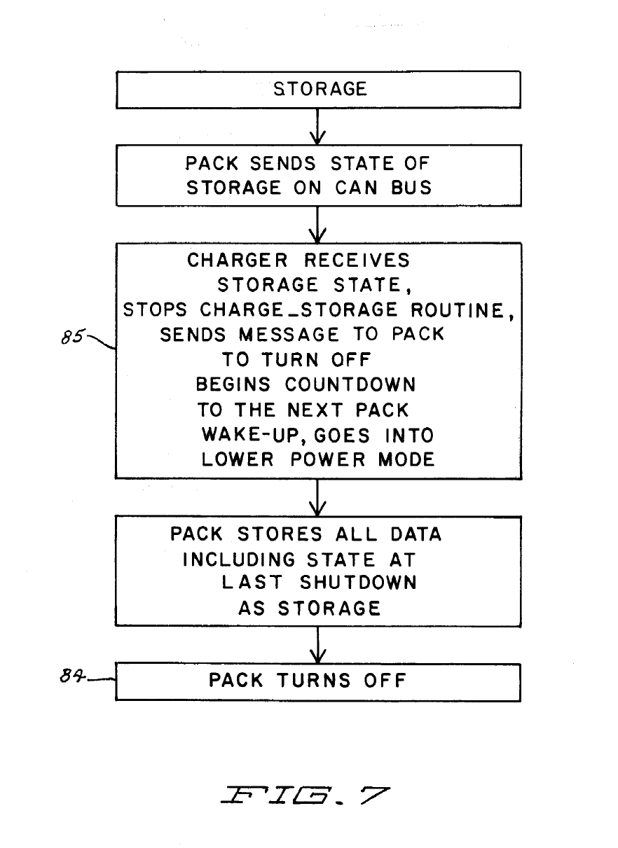

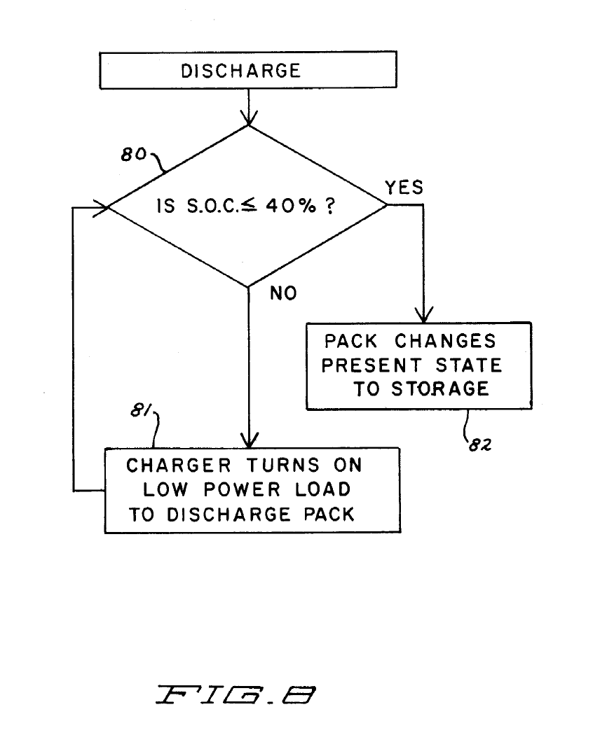

The Pack State At Last Shutdown routine provides a pack present state that may be any one of the following choices:
Charge (the Charge routine of FIGS. 4A-4C);
Charge_Storage (the Charge_Storage routine of FIGS. 5A-5B);
Charge_Done (the Charge_Done routine of FIG. 6);
Storage (the Storage routine of FIG. 7); and
Discharge (the Discharge routine of FIG. 8).
   The answer provided by the Pack State At Last Shutdown routine above determines which routine is performed next.

Turning now to the Charge routine set forth in FIGS. 4A-4C, when this routine is invoked, charger 34 will begin a process by which it sends current to pack 12 to bring pack 12 to a fully charged level where SOC is 100%. However, a timer is started at the beginning of the Charge routine to time an 18 hour charge duration period. Thus, the first logic block 68 in the Charge routine is to determine if the 18 hour charge duration period has timed out. If it has, the Charge routine is deemed to be concluded and charger 34 commands the pack present state to Charge_Done at block 69. Pack 12 then changes its present state to Charge_Done at block 73. The 18 hour is a timeout period to prevent overcharging pack 12 but also terminates a cell balancing process to be described shortly if the cell balancing process takes too long.

If the 18 hour charge duration period has not timed out, charger 34 sends at block 70 the current level that pack 12 has identified to charger 12 as being the current level it requires. The application of electrical current to pack 12 begins charging pack 12. When pack 12 reaches a 100% SOC as determined in logic block 71, an additional logic block 72 determines if the current voltage differences between the various cells in pack 12 are equal to or less than a predetermined minimum. This is a measure of how well the charge is distributed among the different cells in pack 12—a characteristic known as cell balance. If the voltage differences are equal to or lower than a predetermined minimum, the pack is deemed to be adequately balanced. Thus, a Yes answer to the cell balance question at logic block 72, branches to block 73 in which pack 12 changes its present state to Charge_Done.

The remaining portion of the Charge routine is dedicated to allowing pack 12 to rebalance its cell—a process that pack 12 will do without requiring any current flow from charger 12. Thus, block 74 of the Charge routine commands that charger 34 apply a current level of 0.0 amps to pack 12. Pack 12 then goes through an internal cell balancing process at block 75. The cell balancing process will use energy, and thus reduce the pack SOC. To ensure that pack 12 is ready for use at a high SOC on the next day, the cell balance process is stopped when the SOC falls below 98%. If this is determined to have happened as shown at logic block 76, charger 34 will again start supplying current to pack 12 at block 70 to increase the SOC. Nonetheless, at the conclusion of the 18 hour charge duration period or when the SOC is returned to 100% with the cells being balanced, the Charge routine will be concluded and the pack will change its present state to Charge_Done.

To reiterate, a pack present state of Charge_Done occurs in FIG. 4 in two different ways. If the 18 hour time charge duration limit has been exceeded, charger 34 will command pack 12 to the present state of Charge_Done in block 69 whereupon the pack will then change its present state to Charge_Done in block 73. If the pack is properly charged and balanced prior to the 18 hour charge duration period expiring, pack 12 will change its state—on its own accord—to Charge_Done, as indicated in block 73. The net effect of the Charge routine is to bring the SOC of pack 12 up to 100% and with the cells of pack 12 having been balanced. In this condition, battery 12 is ready for use in mowing.

If a mower 2 with a fully charged pack 12 is not used for mowing within a reasonable period of time, the Applicants have realized that it is harmful to a lithium ion pack to remain at a high state of charge for a long, uninterrupted time. This will dramatically shorten the life of pack 12. Given the high costs of a lithium ion pack 12, this is very disadvantageous. Thus, battery pack 12 and charger 34 uses two further routines, namely the Charge_Done routine and the Discharge routine, to solve this problem to extend the life of pack 12, namely to allow pack 12 to have more cycles of operation than if it is stored at high charge levels for long periods of time. The Charge_Done routine and Discharge routines will now be described in conjunction with FIGS. 6 and 8.

Referring first to FIG. 6, the Charge_Done routine is fairly simple. As indicated in block 78, charger 34 will stop charging pack 12, will send a message to pack 12 to shut off, and will itself revert to a low power standby mode. However, an important function performed by charger 34, which is also indicated in block 78, is to begin timing a countdown for a Charge_Done sleep period that must elapse before charger 34 wakes pack 12 up again. This Charge_Done sleep period may have different durations. However, one duration used by the Applicants is a Charge_Done sleep period of 10 days from the start of the Charge routine. Thus, after the Charge_Done routine shuts off pack 12 at block 79, charger 34 is still operational in its lower power standby mode and is counting down to the end of the Charge_Done sleep period. At the end of this Charge_Done sleep period and upon the awakening of pack 12 by charger 34, the next routine that will be run will be the Discharge routine.

The Discharge routine as shown in FIG. 8 is also very simple. It has a single logic block 80 that determines if the SOC of pack 12 is less than or equal to the SOC storage high limit, e.g. 40% SOC. If the answer is NO meaning that the SOC of pack 12 is higher than 40%, charger 34 applies a low power load to pack 12 to begin discharging pack 12. This discharge is indicated at block 81 of FIG. 8. This discharge continues until the SOC of pack 12 is reduced to 40% or less. At this point, logic block 80 branches to block 82 in which pack changes its present state to Storage. The purpose of the battery pack 12 changing its state to Storage is to communicate to the charger 34 that the discharge is complete. Effectively, the purpose of the Discharge routine of FIG. 8 is to take a pack 12 that is at a high state of charge, namely at 100% or at whatever lesser but still high SOC that will result from natural charge loss over the Charge_Done ten day sleep period, and affirmatively reduce that high SOC to a dramatically lower SOC having the value of the SOC storage high limit once the Charge_Done ten day sleep period has elapsed and the discharge begins. The value of the SOC storage high limit could have been chosen to be any reasonable reduced value of the SOC as dictated by battery chemistry. In this case, the Applicants chose the indicated 40% SOC as the SOC storage high limit.

After the Discharge routine of FIG. 8 has concluded and the pack state has been set to Storage, the Storage routine is then invoked. The Storage routine is shown in FIG. 7. Basically, the Storage routine is much like the Charge_Done routine. The basic purpose of the Storage routine is to shut off pack 12 at block 84, namely to put pack 12 back to sleep. But, like the Charge_Done routine, the Storage routine begins a timed countdown in block 85 for a Storage sleep period. The Storage sleep period may have a value that is different from the Charge_Done sleep period. However, the Applicants have set the Storage and Charge_Done sleep periods to the same values, namely 10 days. Thus, charger 34 will countdown 10 days from the conclusion of the Storage routine. At the end of this 10 day Storage sleep period, charger 34 will awaken pack 12 again to ensure the pack has no faults and has a SOC between the aforementioned SOC storage high limit and a SOC storage low limit. As with the SOC storage high limit, the Applicants could have chosen any reasonable value for the SOC storage low limit as dictated by battery chemistry. In this case, the Applicants chose to set the SOC storage low limit at 30% SOC.

Once pack 12 is awakened after the Storage sleep period has timed out, the Charge_Storage routine will be performed. The Charge_Storage routine is shown in FIGS. 5A-5B. The Charge_Storage routine has a first logic block 86 that checks to see if the SOC of pack 12 is greater than 40%. If the answer is Yes, the Charge_Storage routine branches to block 87 to invoke the Discharge routine to begin discharging pack 12 to a SOC level that is less than 40%. If the answer is NO at logic block 86, the Charge_Storage routine then checks at logic block 88 to see if the SOC is between 30% and 40%. If it is, charger 34 commands pack 12 to the Storage state at block 89. However, if the SOC has fallen below 30%, then charger 34 begins charging pack 12 again at block 90.

The Charge_Storage routine then includes logic block 91 where the battery pack continually checks the SOC to determine if the SOC remains less than 40%. Once the answer to this turns NO, that means the charging occurring at block 90 has returned the SOC to a 40% level. At this point, the pack 12 changes its present state to Storage. As previously discussed, the Storage routine of FIG. 7 will again be started. The net effect of the method of battery management described above is as follows. Importantly, if a lithium ion battery pack 12 is fully charged and the mower is used on a fairly continuous basis, i.e. daily or every other day, battery pack 12 will be depleted during one cycle of use when connected to a Charger 12 in Standard operating mode, will be recharged at the end of that cycle of use, and will return to operation without the Discharge routine or Charge_Storage routines ever coming into play. In a sense, pack 12 is in a fairly continuous state of discharge followed by charge cycles that are close to each other in time, i.e. from one day to the next or from a Tuesday to a Thursday or the like.

However, if mower 2 is for some reason connected to charger 34 in Standard operating mode and then is out of use for an extended period of time, the battery management method of this invention will actively and affirmatively discharge a pack 12 that is substantially fully charged to a much lower level after the Charge_Done sleep period expires. Following that discharge, the SOC of pack 12 is checked at the end of each successive Storage sleep period to see whether or not the SOC is in a desirable storage range of from 30% to 40% SOC. If it is, nothing happens and this monitoring of the SOC continues through successive Storage sleep periods. However, if it outside this desirable storage range, it is then returned to the 30% to 40% SOC level. Effectively, for a mower that is not being used, a fully charged pack 12 will be initially discharged from a high SOC level to a low SOC level and the battery SOC will be indefinitely maintained thereafter (as long as pack 12 is connected to charger 34) at a low SOC storage range of between 30% and 40% SOC.

The Applicants have discovered that this methodology will enhance the life of lithium ion pack 12. Given the expense of such pack 12, this is an advantage. Moreover, use of lithium ion pack 12 gives mower 2 superior range over similar electrically powered mowers having lead acid battery packs. Mower 2 can cut many more greens than mowers with lead acid battery packs. Thus, while lithium ion pack 12 is more expensive, it facilitates mowing as the operator need not stop as frequently to recharge or to swap one battery pack for another as is the case with lead acid battery packs.

It should be noted that the user can selectively change charger 34 from its Standard operating mode to its Storage operating mode via an internal switch. The storage mode would be used at a distribution center or at a warehouse where packs 12 may be in storage for long periods of time. The charger in Storage mode will maintain a pack 12 at 30% to 40% SOC for long periods of time.

Various modifications of this invention will be apparent to those skilled in the art. For example, the battery management system and method of this invention could be used with batteries other than lithium ion batteries when such batteries are of a type that experience shortened lives if such batteries are maintained at high states of charge for too long. Additionally, the battery management system and method of this invention could be used on outdoor power equipment units other than mowers, such as on utility vehicles of the type manufactured and sold by The Toro Company under the Workman® brand name, or grooming vehicles manufactured and sold by The Toro Company under the Sand Pro® brand name, blowers, trimmers, etc. Thus, the scope of this invention is to be limited only by the appended claims.

1. A method, which comprises:
(a) providing a mower for cutting grass having at least one electric motor carried thereon for driving at least one component of the mower with a battery pack being carried on the mower for providing electrical power to the electric motor;
(b) providing a charger for charging the battery pack; and
(c) managing the state of charge of the pack in the following manner:
(i) using the charger to charge the battery pack to a substantially fully charged state of charge level; and
(ii) discharging the battery pack to a state of charge level that is reduced compared to the fully charged state of charge level at the conclusion of a predetermined period of time if the mower was not used since the fully charged state of charge level was established.

2. The method of claim 1, wherein the battery pack is a lithium ion battery pack.

3. The method of claim 1, further including the step of maintaining the battery pack in the reduced state of charge following the discharging step.
